(19) United States
(12) Patent Application Publication
(10) Pub. No.: US 2019/0219718 A1
(43) Pub. Date: Jul. 18, 2019

(54) Dipole Shear Velocity Estimation

(71) Applicant: Halliburton Energy Services, Inc., Houston, TX (US)

(72) Inventors: Mark Vincent Collins, Spring, TX (US); Kristoffer Thomas Walker, Kingwood, TX (US)

(73) Assignee: Halliburton Energy Services, Inc., Houston, TX (US)

(21) Appl. No.: 15/578,603

(22) PCT Filed: Oct. 26, 2016
(86) PCT No.: PCT/US2016/058916

§ 371 Date: Nov. 30, 2017

(51) Int. Cl. G01V 1/50; G01V 1/28; G01V 1/52

(52) U.S. Cl. CPC G01V 1/50; G01V 1/286; G01V 2210/6222; G01V 2210/43; G01V 2210/47; G01V 1/52

(57) ABSTRACT

Methods for well logging may comprise recording a pressure wave at a dipole receiver, processing the pressure wave with a Fourier transform, computing a frequency semblance from the Fourier transform, computing an adaptive weighting function, and estimating a shear wave slowness. A method for well logging may further comprise disposing a downhole tool into a borehole, activating the dipole transmitter, sensing the pressure wave with the dipole receiver, recording the pressure wave, processing the pressure wave with a Fourier transform, computing a frequency semblance from the Fourier transform, and estimating a shear wave slowness. Estimating shear wave slowness may comprise producing one or more adaptive weights, a combination of a coherence map, and a dispersion curve. Estimating shear wave slowness may further comprise preparing an acoustic well log from the adaptive weights, the combination of the coherence map, and the dispersion curve.

### BACKGROUND

For oil and gas exploration and production, a network of wells, installations and other conduits may be established by connecting sections of metal pipe together. For example, a well installation may be completed, in part, by lowering multiple sections of metal pipe (e.g., a casing string) into a borehole, and cementing the casing string in place. In some well installations, multiple casing strings are employed (e.g., a concentric multi-string arrangement) to allow for different operations related to well completion, production, or enhanced oil recovery (EOR) options.

The development of underground formations such as hydrocarbon reservoirs may be an ongoing process. Well logs may be generated that provide a record of one or more properties of the formations and/or the wellbore. In particular, analyzing well logs may allow an operator to evaluate, as a function of depth, quantitative properties representative of formations.

### BRIEF DESCRIPTION OF THE DRAWINGS

These drawings illustrate certain aspects of some examples of the present disclosure, and should not be used to limit or define the disclosure.

FIG. 1 is a schematic illustration of a well system;

FIG. 2 is a schematic illustration of downhole tool;

FIG. 3 is a flow chart to estimate shear wave velocity;

FIG. 4 is a graph of a coherence map with overlaid dispersion curve;

FIG. 5 is a graph of the group delay showing that the group delay in the low frequency horizontal part of the dispersion curve has less variance than at other frequencies.

FIG. 6a is a graph of an enhanced part of a low frequency horizontal part of a dispersion curve;

FIG. 6b is a graph of selecting recorded data from recorded noise;

FIG. 7a is a graph of a Variable Density Log;

FIG. 7b is a graph of a second Variable Density Log;

FIG. 7c is a graph of FIG. 7a slowness velocity compared to a dispersion curve;

FIG. 7d is a graph of FIG. 7b slowness velocity compared to a dispersion curve; and

FIG. 8 is a schematic illustration of a drilling system.

### DETAILED DESCRIPTION

This disclosure may generally relate to well logging and, more particularly, to methods for determining a near real time acoustic well log by estimating the shear wave velocity from dipole waveforms. By estimating shear wave velocity from dipole waveforms with minimal human intervention, a real time acoustic well log of shear slowness versus depth may be produced. This may provide an operator with a picture of the hydrocarbon reservoir in a formation.

Bulk modulus, shear modulus, Young's modulus, and Poisson's ratio may be parameters for characterizing the mechanical properties of a rock formation. These mechanical properties may be implemented to estimate borehole stability, sanding potential, fracture strength, and a number of other related parameters, which may determine a procedure for well completion and production. The mechanical properties may be functions of the compressional (P) and shear (S) acoustic wave velocities and rock density. Production companies typically want to make reservoir development decisions, thus providing accurate acoustic well logs as a function of reservoir depth in real and/or near real time on-site at the well with minimal human intervention may be desirable.

Acoustic logging tools may fire acoustic sources with different azimuthal symmetries to measure acoustic velocities. In fast isotropic formations, the P and S wave velocities may be estimated from refracted P and S acoustic waves excited by an axi-symmetric (monopole) source. These refracted P and S waves may be non-dispersive and may allow for direct estimation of the wave velocities (or slownesses) using a variety of time or frequency semblance techniques. Two guided wave modes may exist, the pseudo-Rayleigh mode and the Stoneley mode. It may be possible, but more difficult, to estimate shear velocity from the guided waves because of mutual interference, dispersion, and sensitivity to other parameters. However, this may not be an issue since the refracted shear wave exists. Unfortunately, in slow formations there is no critical refraction and neither the refracted shear wave or pseudo-Rayleigh wave exist. Thus, the shear velocity must be estimated from another guided wave in a slow formation. The Stoneley mode dispersion curve may not necessarily approach the shear velocity at any frequency, unlike the pseudo-Rayleigh, which approaches the shear velocity at its low-frequency cut-off. Consequently forward modeling is necessary to estimate the shear velocity from the Stoneley mode, and this modeling may be dependent on other parameters, most notably the borehole fluid velocity. In examples, it may be more desirable to utilize flexural guided waves, generated by an asymmetric dipole source, to estimate shear velocity. The flexural mode dispersion curve, like the pseudo-Rayleigh wave, approaches the shear velocity near a low frequency cut-off making it possible to directly estimate the shear velocity. However, unlike the pseudo-Rayleigh mode, the flexural mode exists in both slow and fast formations, making it the guided wave of choice for estimating shear velocity.

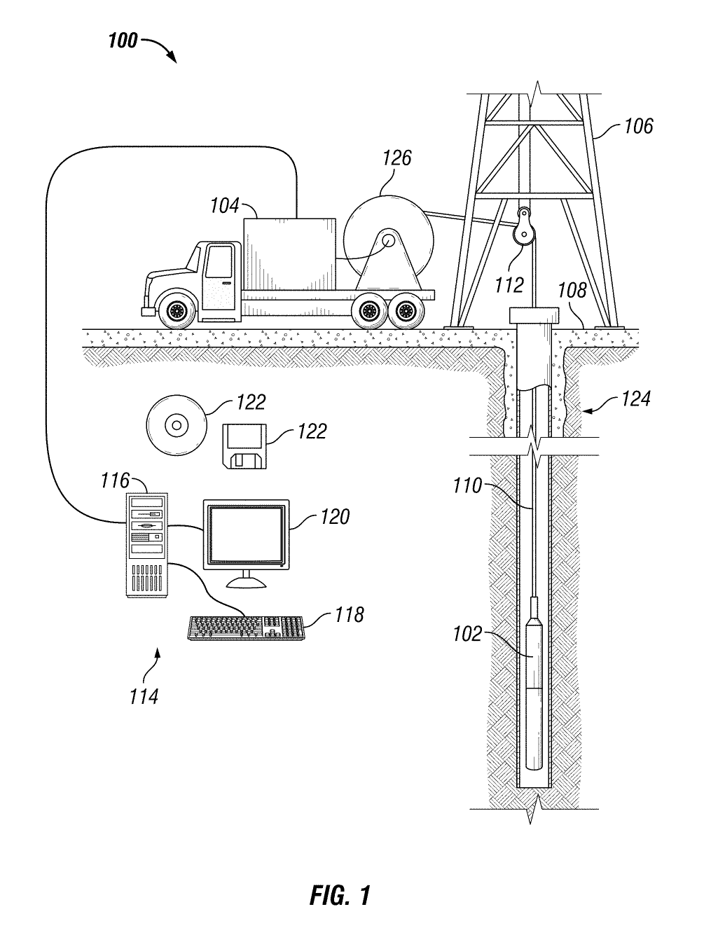

FIG. 1 illustrates a cross-sectional view of a well system 100. As illustrated, well system 100 may comprise a downhole tool 102 attached to a vehicle 104. In examples, it should be noted that downhole tool 102 may not be attached to a vehicle 104. As illustrated, downhole tool 102 may be supported by derrick 106 at surface 108. Downhole tool 102 may be tethered to vehicle 104 through conveyance line 110 (e.g., wireline, slickline, coiled tubing, pipe, or the like) which may provide mechanical suspension, as well as electrical connectivity, for downhole tool 102. Conveyance line 110 may be disposed around one or more sheave wheels 112 to vehicle 104. Conveyance line 110 may comprise an inner core of a plurality of electrical conductors covered by an insulating wrap. An inner and outer steel armor sheath may be disposed around the conductors. Where present, the electrical conductors may be used for communicating power and telemetry between vehicle 104 (or other equipment) and downhole tool 102. Information from downhole tool 102 may be gathered and/or processed by information handling system 114. Alternatively, information may be stored on downhole tool 102 and recovered when the downhole tool 102 is returned to surface 108.

Systems and methods of the present disclosure may be implemented, at least in part, with information handling system 114. Information handling system 114 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 114 may include a computer 116, a network storage device, or any other suitable device and may vary in size, shape, performance, functionality, and price. Information handling system 114 may include random access memory (RAM), one or more processing resources such as a central processing unit (CPU) or hardware or software control logic, ROM, and/or other types of nonvolatile memory. Additional components of the information handling system 114 may include one or more disk drives, one or more network ports for communication with external devices as well as various input and output (I/O) devices, such as a keyboard 118, a mouse, and a video display 120. Information handling system 114 may also include one or more buses operable to transmit communications between the various hardware components. In embodiment, information handling system 114 may be disposed with conveyance line 110 downhole. Information handling system 114 may be disposed at any location within and/or on the outside of conveyance line 10.

Alternatively, systems and methods of the present disclosure may be implemented, at least in part, with non-transitory computer-readable media 122. Non-transitory computer-readable media 122 may include any instrumentality or aggregation of instrumentalities that may retain data and/or instructions for a period of time. Non-transitory computer-readable media 122 may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

In examples, derrick 106 includes a load cell (not shown) which determines the amount of pull on conveyance line 110 at the surface of borehole 124. Information handling system 114 may comprise a safety valve which controls the hydraulic pressure that drives drum 126 on vehicle 104 which may reel up and/or release conveyance line 110 which may move downhole tool 102 up and/or down borehole 124. The safety valve may be adjusted to a pressure such that drum 126 may only impart a small amount of tension to conveyance line 110 over and above the tension necessary to retrieve conveyance line 110 and/or downhole tool 102 from borehole 124. The safety valve is typically set a few hundred pounds above the amount of desired safe pull on conveyance line 10 such that once that limit is exceeded, further pull on the conveyance line 110 is prevented.

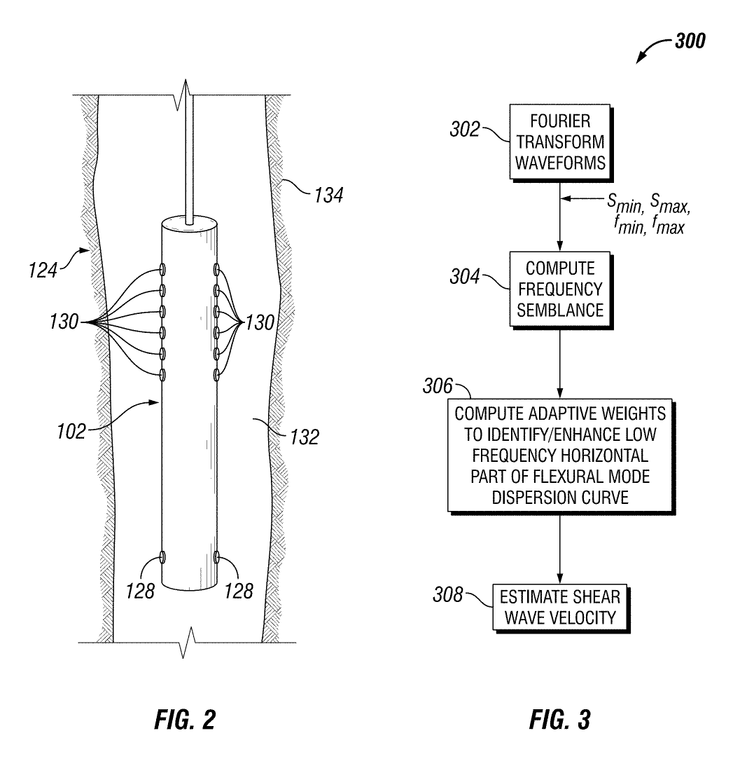

FIG. 2 illustrates downhole tool 102, specifically an acoustic dipole configuration. It should be noted that downhole tool 102 may comprise any configuration suitable to operation described within this disclosure. As illustrated, downhole tool 102 may be disposed within borehole 124 along a vertical axis. In examples, downhole tool 102 may comprise a dipole transmitter 128. Non-limiting examples of a suitable dipole transmitter 128 may include piezo-electric bender bars or electro-magnetic shakers. Dipole transmitter 128 may be polarized normal to the tool axis (horizontally in the figure) along any azimuth as long as the dipole receivers 130 are polarized along the same azimuth. Additionally, there may be any number of dipole-transmitters 128 as long as there are corresponding dipole receivers 130 with the same polarization for achieving good response. As an example a traditional cross-dipole acoustic tool has azimuthally orthogonal dipole transmitters and corresponding azimuthally orthogonal receiver arrays. Downhole tool 102 may further comprise an array of dipole receivers 130. The figure shows six dipole receivers 130 in the array uniformly spaced along the vertical axis of the downhole tool 102 and polarized in the same direction as the dipole transmitter 128. Non-limiting examples of a suitable dipole receivers 130 may include hydrophones or piezo-electric sensors. Additionally, there may be any number greater than one of dipole receivers 130 disposed in the array with equal or unequal spacing along the downhole tool 102. In examples, dipole transmitter 128 may generate an azimuthally asymmetric acoustic pressure wave (not illustrated) that may propagate through drilling fluid within borehole 124. The acoustic pressure wave may be converted to shear (not illustrated) at borehole wall 132 and excite the flexural mode (not illustrated) in formation 134. The flexural mode may propagate down borehole 124, convert back into a pressure wave at borehole wall 132, and may impinge on dipole receivers 130. The pressure exerted on each of dipole receivers 130 may be recorded by information handling system 114. Pressure waves recorded on opposite sides of downhole tool 102 at the same vertical level may be differenced to create a dipole signal, which may remove possible symmetric Stoneley contamination. The pressure waves recorded may be referred to as waveforms. As disclosed below, a method for estimating the shear velocity from dipole waveforms produces a real time acoustic well log of shear slowness (defined as the inverse of velocity) at the depth in which the recording was made.

FIG. 3 illustrates a flow chart for a method 300 of estimating shear wave slowness (or equivalently velocity). Shear wave slowness may be obtained through processing pressure waves recorded by dipole receivers 130. The recorded pressure waves, or waveforms, may be processed by a Fourier Transform in block 302. Known variables may be added to the Fourier Transform to compute frequency semblance in block 304. The known variables may include a minimum slowness value (sₘᵢₙ), a maximum slowness value (sₘₐₓ), a minimum frequency value (fₘᵢₙ) and/or a maximum frequency value (fₘₐₓ). From this information adaptive weights to identify/enhance the low frequency horizontal part of the flexural mode dispersion curve may be computed in block 306. From the information obtained in block 306, shear wave slowness (or equivalently velocity) may be estimated in block 308.

In examples, before performing a Fourier Transform of recorded waveforms in block 302, steps for masking in the time domain may be implemented to remove noise events that may be temporally separated from a flexural mode. For example, if the P-mode may be temporally separated from the flexural mode, it may be masked out to reduce the P-mode energy in the flexural modes frequency region of interest (i.e. the low-frequency horizontal portion of the flexural mode dispersion curve). P-mode energy with low frequency may be weak and may not be a problem. In examples, temporal masking of various types of noise may not be automated for all situations, and recorded noise may not be localized, thus attempting to mask it out may introduce more noise due to the Gibbs phenomenon. After masking, the data may be zero-padded and Fourier transformed. The zero-padding may be used to achieve a desired frequency sample period based on processing execution time. The frequency band of interest may be kept and the data at other frequencies may be discarded. The kept frequency band should extend above and below the low frequency horizontal part of the flexural mode dispersion curve. Typically frequencies of the waveforms from a few 100 Hz to ˜8-10 KHz may be kept for further processing. The Fourier transformed waveforms may be denoted as Xₙ(fₘ), m=0, . . . , N_{F}−1, where N_{F} is the number of saved frequency filters out of the FFT, and fₘ are the FFT frequencies. n=0, . . . , N_{R}−1 is the receiver index where N_{R} is the number of receivers in the array.

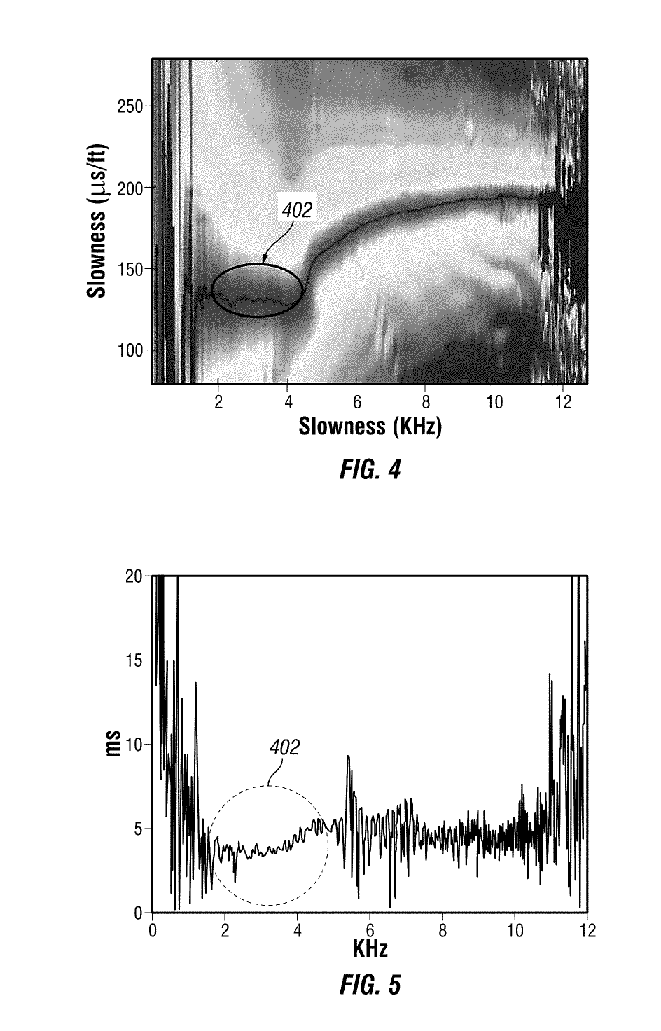

Results from the Fourier Transform of waveforms in block 302 may be processed with a frequency semblance in block 304. Frequency semblance may compute a two-dimensional coherence map over slowness and frequency, as illustrated in FIG. 4. The slowness bounds may depend on the slowness values (dtc, dist) of other modes (P-wave, Stoneley) which may be assumed to be available from other log tracks in real-time, or the borehole fluid slowness (dtf), which is usually known fairly well from the mud type. In examples, a fast formation may set the lower slowness bound to dtcₜₕᵣₑₛₕ*dtc and the upper bound to dtf, where the proportionality for dtc may be 1<dtcₜₕᵣₑₛₕ<1.4. The lower bound on the slowness may be chosen to remove the majority of the P/leaky P modes from the 2D coherence map. The upper slowness bound may be set to a large fixed number based on the expected shear slowness range in borehole 124 (Referring to FIG. 1). One embodiment for a slow formation may set the lower slowness bound as max(dtf, dtcₜₕᵣₑₛₕ*dtc), and the higher velocity as dtstₜₕᵣₑₛₕ*dtst where a Stoneley slowness dtst may be estimated from a high frequency monopole source, and the proportionality dtstₜₕᵣₑₛₕ˜1.

Frequency semblance in block 304 (Referring to FIG. 3) may be separated into two categories. A first category in which the frequency semblance may output slowness values for one or several modes as a function of frequency, and a second category in which the frequency semblance may produce a two-dimensional (“2D”) coherence map over slowness and frequency (e.g., FIG. 4). Examples of the first category may include Prony's method and Matrix Pencil. Examples of the second category may include weighted spectral semblance and Differential Phase Frequency Semblance (DPFS). The second category of the frequency semblance may create a 2D coherence map where the magnitude may be bounded between 0 and 1. A high value of coherence indicates a mode may be present at that slowness and frequency. The first category of the frequency semblance may not create a coherence map, they may generate mode slowness values. An auxiliary fitness function may be computed with characteristics equivalent to a coherence map, as illustrated in FIG. 4. The fitness function may be bounded between 0 and 1, may have a value of 1 at the mode slowness values, and decays as the slowness departs from the mode slowness values. The fitness function may be denoted as a coherence map in the remainder of the document. The coherence maps from many depths may be compressed in frequency to produce a Variable Density Log (VDL) track of slowness versus depth. A VDL may be used to identify a reservoir (not illustrated) within formation 134 (Referring to FIG. 2). The shear velocity at each depth may be overlaid on the VDL. Low coherence background noise may be removed by setting the coherence in the 2D map to zero when it drops below a threshold. This may be referred to as a masked coherence map, MC(sₖ, fₙ), where sₖ may be the slowness values.

Referring to FIG. 4, a dispersion curve 402 may be computed from the semblance results. The term “dispersion curve” may be described as a one-to-one mapping of frequency to slowness over the frequency band. The slowness of the internal frequencies may be reasonably good estimates of the flexural mode slowness and include a portion of the low frequency horizontal part of the flexural mode dispersion curve, and the estimates may be worse at the extremities of the frequency band. Some frequencies may be identified and labeled as having invalid slowness values. In examples, the dispersion curve may select the P/Leaky P alias at higher frequencies if it exists instead of the flexural mode. If the P slowness is available from other sources, such as a real-time compressional slowness log track, it may be possible to label these frequencies as invalid.

In examples, dispersion curve 402 may be determined from the second category of frequency semblance which may produce a 2D coherence map. The dispersion curve (slowness vs. frequency) is determined as the slowness of maximum coherence at each frequency. The slowness of maximum coherence may be calculated by quadratic interpolation of the coherence in the slowness dimension at about the maximum coherence pixel at each frequency. If the selected slowness is on the boundary of the coherence map because the maximum coherence is outside the map bounds, it may be labeled as invalid. In examples, dispersion curve 402 for the first category of frequency semblance may be determined from the one or more mode slowness values output by the frequency semblance at each frequency. The complex amplitude of each mode at each frequency may be determined by the frequency semblance. For example, a least squares method may be implemented by Prony's method. Dispersion curve 402 may be the slowness of the largest amplitude mode at each frequency. It may be expected that dispersion curve 402 may get noisy at low and/or high frequency and may jump to another mode. This may be acceptable as the semblance algorithm may automatically reject these frequencies.

Referring to FIG. 3, block 306 may take the results from the frequency semblance (block 304) to compute adaptive weights to identify/enhance the low frequency horizontal part of the flexural mode dispersion curve. Referring to FIG. 5, adaptive weights as a function of frequency may be computed to enhance the low frequency horizontal part of dispersion curve 402. The adaptive weights may be computed from one or more metrics. In examples, the variance of the dispersion curve, DTX (f), may be used to compute the weights. In examples, the variance of the group delay, GD (f), may be used to compute the weights. Both variances and the smoothed group delay may be used to compute the weights. Other optional metrics may be used in addition to those stated above. For example, the variance of the coherence values on dispersion curve 402 may be used. Group delay may be numerically defined as:

$$GD ( {f}_{GD , m} ) = \frac{1}{2 π {N}_{R}} {\sum }_{n = 0}^{{N}_{R} - 1} \frac{1}{[ {X}_{n} ( {f}_{m + 1} ) + {X}_{n} ( {f}_{m} ) ]} \cdot \frac{[ {X}_{n} ( {f}_{m + 1} ) - {X}_{n} ( {f}_{m} ) ]}{Δ f} \qquad ( 1 )$$

where Xₙ(fₘ) are the Fourier transformed waveforms and f_{GD,m}=0.5*(fₘ₊₁+fₘ). The group delay is resampled back onto the FFT grid, GD (fₘ).

In examples, computing the weights from the variance of a metric (e.g. the dispersion curve slowness, group delay, etc.) may be computed as

$$\begin{matrix}{σ}_{M , n}^{2} = \frac{1}{{N}_{BW} + 1} {\sum }_{m = - {N}_{BW} / 2}^{{N}_{BW} / 2} {[ M ( {f}_{n + m} ) - \overline{{M}_{n}} ]}^{2} \\ where & ( 2 ) \\ \overline{{M}_{n}} = \frac{1}{{N}_{BW} + 1} {\sum }_{m = - {N}_{BW} / 2}^{{N}_{BW} / 2} M ( {f}_{n + m} ) . & ( 3 )\end{matrix}$$

M is the metric and N_{BW}+1 is the number of frequencies in a narrow processing bandwidth window. The bandwidth may be about 200-400 Hz. In examples, invalid frequencies may have values set to large oscillatory numbers to create a large variance. The invalid frequencies may be excluded from the calculation and the variance at these frequencies may be set to a larger number. The variances as computed in equation (2) may assume the metrics may be flatter as a function of frequency in the horizontal part of dispersion curve 402 (Referring to FIG. 5), and that the variances may grow at low and high frequency due to increased noise in the signal. The final weighting, Ωₙ, may be determined from

Ωₙ=TₙBₙWₙ (4)

where Bₙ is a rectangular binary mask computed from the metrics (adaptive). Tₙ is a non-adaptive taper or shaping function (shape is independent of the metrics), and Wₙ is a set of initial adaptive weights computed from the metrics. In examples, the weights, Wₙ may be

$${W}_{n} = \frac{{σ}_{DTX , n}^{- 1}}{{max}_{n} {σ}_{DTX , n}^{- 1}} . \qquad ( 5 )$$

where σ²_{DTX,n} is the variance of the dispersion curve at frequency index n. The initial weights may be calculated as:

$${W}_{n} = \frac{{σ}_{n}^{- 1}}{{max}_{n} {σ}_{n}^{- 1}} . \qquad ( 6 )$$

where σₙ is the geometric mean of the standard deviations of all the metrics:

$${σ}_{n} = {( {\prod }_{M}^{{N}_{M}} {σ}_{M , n} )}^{1 / {N}_{M}} \qquad ( 7 )$$

In equation (7) σ_{M,n} is the standard deviation of metric M at frequency index n and N_{M} is the number of metrics. In examples, the initial weights use the metrics to emphasize the horizontal smooth part of dispersion curve 402.

The binary rectangular mask, Bₙ, may be applied to zero out undesired frequencies at the low and high ends of the spectrum. In examples, the binary mask may be one for all frequencies (no mask). The binary mask may be computed by comparing a frequency dependent function, Fₙ, to a threshold. The function, Fₙ, may be calculated from the metrics. Additionally, the function may be the initial weights, Fₙ=Wₙ. The function may be computed as:

$${F}_{n} = \frac{{σ}_{n}^{- 1}}{{max}_{n} {σ}_{n}^{- 1}} \cdot \frac{1}{{GDS}_{n}^{p}} \qquad ( 8 )$$

where GDS is the group delay after smoothing with a low-pass filter, and p is a small positive integer. The smoothed group delay tends to be minimized in the low frequency horizontal part of the dispersion curve just above the flexural mode cut-off. Using the group delay in equation (8) helps to avoid mistakenly windowing very low-frequency Stoneley mode interference or windowing the nearly horizontal slower high frequency part of the flexural mode dispersion curve. In examples, the binary mask may be computed using a threshold. The first non-zero value of the binary mask occurs at frequency index n₁, where n₁ is the first index satisfying a threshold on Fₙ,

Fₙ_{₁}>F_{Thresh} (9)

The last non-zero value of the binary rectangular mask occurs at frequency n₂, where n₂ satisfies:

n₂=n₁+N_{B} (10)

and

N_{B}=min[α(n₃−n₄),BWMAX]. (11)

The indices on the right hand side of equation (9) satisfy summation relations,

$$\frac{{{\sum }^{{n}_{3}}}_{n = 0} {F}_{n}}{{{\sum }^{{N}_{F} - 1}}_{n = 0} {F}_{n}} = {I}_{Thresh} , and \frac{{{\sum }^{{N}_{F} - 1}}_{n = {n}_{4}} {F}_{n}}{{{\sum }^{{N}_{F} - 1}}_{n = 0} {F}_{n}} = {I}_{Thresh} \qquad ( 12 )$$

where typically Iₜₕᵣₑₛₕ≤1. The difference (n₃−n₄>0) may be approximately the width of the dispersion curve 402 (Referring to FIG. 4). The upper half of dispersion curve 402 may have large initial weights. This may occur if dispersion is weak (i.e. the dispersion curve is flat) and there is low variance in the metrics at the upper frequencies. Choosing α=0.5 eliminates the upper portion of dispersion curve 402. In examples, n₂ may further be constrained by an absolute upper bound, BWMAX, on N_{B}.

The taper or shaping function, Tₙ, may be independent of the metrics with regards to its shape (not necessarily its duration) and may be applied to further enhance lower frequencies. In one embodiment the taper may be one (no taper is applied). In another embodiment a typical taper may be a linear ramp from 1 to 0 between n₁ and n₂.

In examples, final weights may use the metrics to isolate and enhance the low-frequency horizontal part of dispersion curve 402 above the flexural mode cut-off. The final weights consist of a product of adaptive (metric dependent) weights, an adaptive binary mask, and a non-adaptive taper or shaping function.

Referring to FIG. 3, the processing from block 306 may be implemented into block 308 to estimate shear wave velocity. In examples, shear wave velocity may be estimated by compressing a 2D function, Γ(sₖ, fₙ) over frequency to create a one dimensional (“1D”) VDL:

$$VDL 1 D ( k ) = {\sum }_{n = {n}_{1}}^{{n}_{2}} Γ ( {s}_{k} , {f}_{n} ) \qquad ( 13 )$$

The position of the peak in the 1D VDL may be found and quadratic interpolation may be used to estimate the shear wave slowness, sₛₕₑₐᵣ. The 2D function, Γ, may be given by:

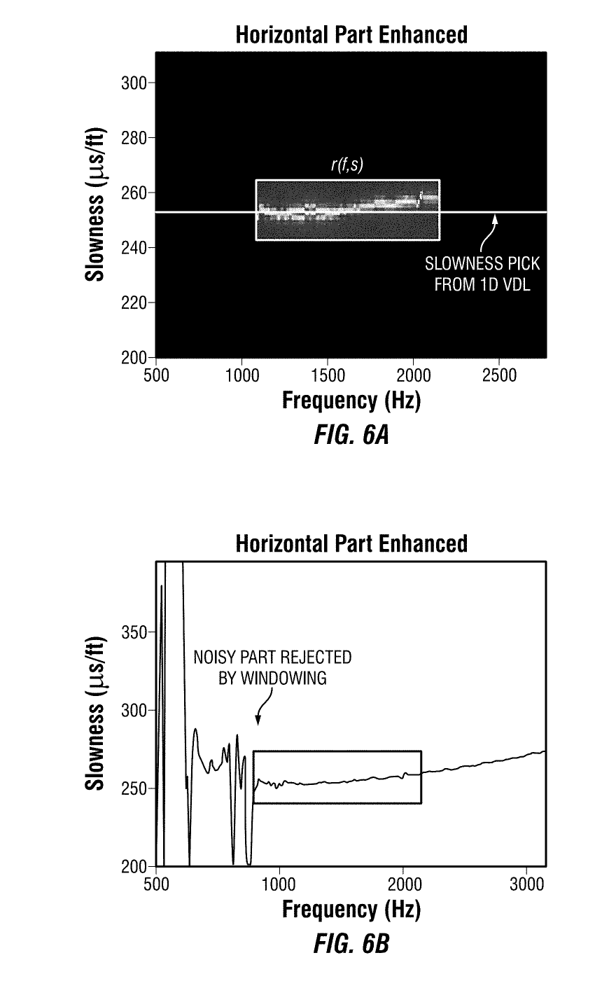

Γ(sₖ,fₙ)=MC(sₖ,fₙ)Ωₙρ(sₖ,fₙ) (14)

where Ωₙ may be the final weights and MC(sₖ, fₙ) may be the masked 2D coherence described previously. ρ(sₖ, fₙ) may be a fitness function computed from the dispersion curve and its variance.

$$ρ ( {s}_{k} , {f}_{n} ) = \frac{{σ}_{DTX , n}^{2}}{{( {s}_{k} - DTX ( {f}_{n} ) )}^{2} + {σ}_{DTX , n}^{2}} \qquad ( 15 )$$

where DTX(fₙ) is the interpolated flexural dispersion curve. The function r and shear slowness estimate (horizontal line) are illustrated in FIG. 6a, and the shear slowness dispersion curve overlaid on the masked coherence is illustrated in FIG. 6b. In examples, the shear velocity may estimate the slowness of the low-frequency horizontal part of dispersion curve 402 (Referring to FIG. 4 or 6b), and the peak in the ID VDL is very thin when the horizontal part of the dispersion curve is clearly visible in the coherence.

In examples, the shear pick may be refined by modifying a parameter of the adaptive weights and re-computing the slowness and 1D VDL. The correct slowness pick and 1D VDL may be determined by locally minimizing an objective function with respect to the modified parameter. For example, the modified parameter may be the upper bound n₂ on the binary mask. Thus we define a 2D VDL as

$$VDL 2 D ( k , n ) = {\sum }_{n = {n}_{1}}^{n \leq {n}_{2}} Γ ( {s}_{k} , {f}_{{n}^{′}} ) \qquad ( 16 )$$

This 2D VDL may represent a set of 1D VDL's. An objective function may be minimized to find the 1D VDL from which to estimate the shear wave slowness. The frequency dependent objective function may be the product of the first and second moments of the slowness along the slowness dimension using the peak normalized 2D VDL as the moment density. The first and second moments correspond to the VDL peak position and VDL thickness respectively. This objective function provides that a 1D VDL may improve with a smaller slowness value without widening the peak. In examples, the 1D VDL may be the one that minimizes the objective function (i.e. finds the first local minimum as the upper frequency limit is decreased). The objective function may be defined as:

$$\begin{matrix} Obj ( {f}_{n} ) = [ MOM 1 ( {f}_{n} ) - {min}_{{n}^{′}} ( MOM 1 ( {f}_{{n}^{′}} ) ) ] MOM 2 ( {f}_{n} ) \\ where & ( 17 ) \\ MOM 1 ( {f}_{n} ) = \frac{{\sum }_{k} {s}_{k} \cdot VDL 2 DN ( {s}_{k} , {f}_{n} )}{{\sum }_{k} VDL 2 DN ( {s}_{k} , {f}_{n} )} = {1}^{′} st moment of s & ( 18 ) \\ MOM 2 ( {f}_{n} ) = \frac{{\sum }_{k} {[ {s}_{k} \cdot MOM 1 ( {f}_{n} ) ]}^{2} \cdot VDL 2 DN ( {s}_{k} , {f}_{n} )}{{\sum }_{k} VDL 2 DN ( {s}_{k} , {f}_{n} )} = {2}^{′} nd moment of s and & ( 19 ) \\ VDL 2 DN ( {s}_{k} , {f}_{n} ) = \frac{VDL 2 D ( {s}_{k} , {f}_{n} )}{{max}_{{k}^{′}} ( VDL 2 D ( {s}_{{k}^{′}} , {f}_{n} ) )} = normalized 2 D VDL & ( 20 )\end{matrix}$$

The frequency index, nₘᵢₙ, of the first objective function minimum may be found searching down in frequency from n₂, and is the chosen 1D VDL for computing the shear slowness,

VDL1D(k)=VDL2D(k,nₘᵢₙ) (21)

As before the position of the peak in the 1D VDL is found and quadratic interpolation is used to estimate the shear slowness, sₛₕₑₐᵣ.

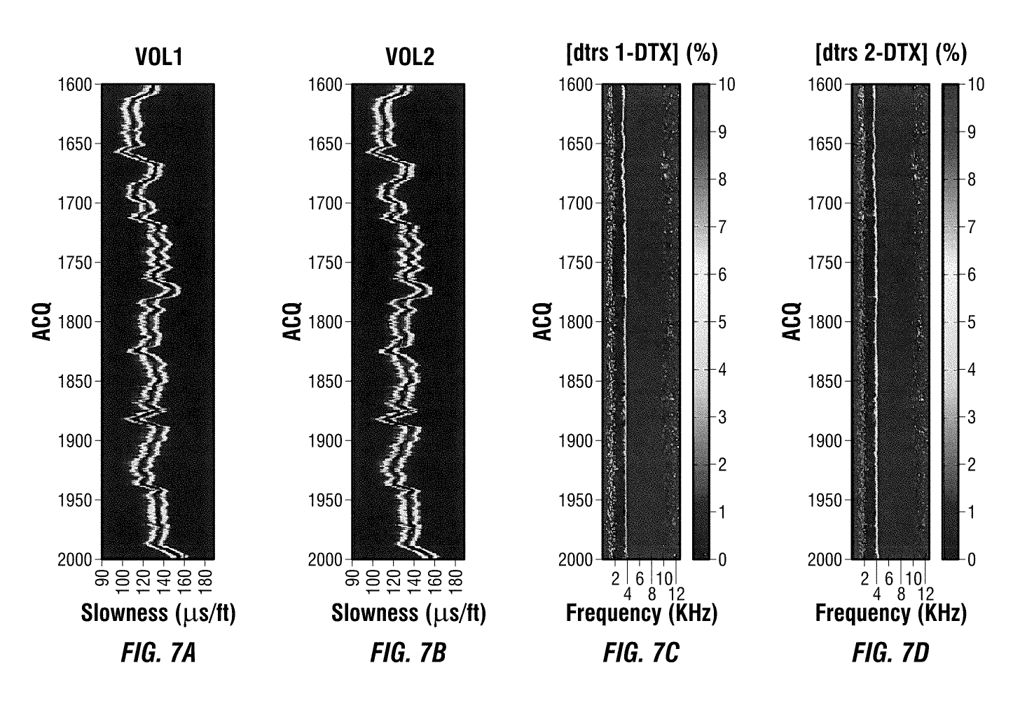

FIGS. 7a and 7b illustrates an example of a first VDL (FIG. 7a) and a second VDL (FIG. 7b) and interpolated slowness picks for 400 acquisitions. These are depth vs. slowness VDLs. The slowness picks may be plotted on top of the VDLs. The first track (going left to right) is the VDL derived from equation (13). The second track is the VDL derived from equation (21). The slowness curves picked from both VDLs may be plotted together on both tracks for easy comparison. The black curve is picked from equation (21) and the white curve from equation (13). The VDLs may be virtually identical and the black curve overlays the white curve. FIGS. 7c and 7d illustrated the percent difference between the slowness picked and the dispersion curve 402 (Referring to FIG. 4) on a ten percent scale. It should be noted that the scale is non-limiting and may be any scale an operator chooses. FIGS. 7c and 7d are depth vs. frequency VDLs computed using

VDLF=100*|DTX(f)−sₛₕₑₐᵣ|/sₛₕₑₐᵣ. (22)

The slowness picked in equations (13) and (21) correspond to tracks on FIGS. 7c and 7d, respectively. The tracks indicate that dispersion curves 402 and slowness picks match well (<2%). This is the case in the 2-4 KHz frequency range. Note that the tracks are adjacent to noise speckle on the lower frequency side. A higher frequency indicates that the slowness picks are far from the dispersion curve 402 (>10% difference). These tracks indicate that the slowness was accurately picked in the low frequency horizontal portion of dispersion curve 402.

The algorithm is statistical in nature and adaptive, so its performance depends on the quality of dispersion curves 402 and recorded waveforms. Poor quality may result in false picks, due to mistakenly picking Stoneley interference and/or picking from the high frequency asymptotic portion of dispersion curve 402. However, the failure rate is so low (typically 1-2 false picks per 1000 acquisitions for reasonable data) that the bad picks may be identified and re-processed. For example, bad picks may be selected with a computer mouse using a rubber-band box and automatically re-processed using the weights from neighboring acquisitions. Alternatively, the dispersion curve 402 of a bad pick may be plotted, in which an operator may manually pick the slowness from the dispersion curve 402.

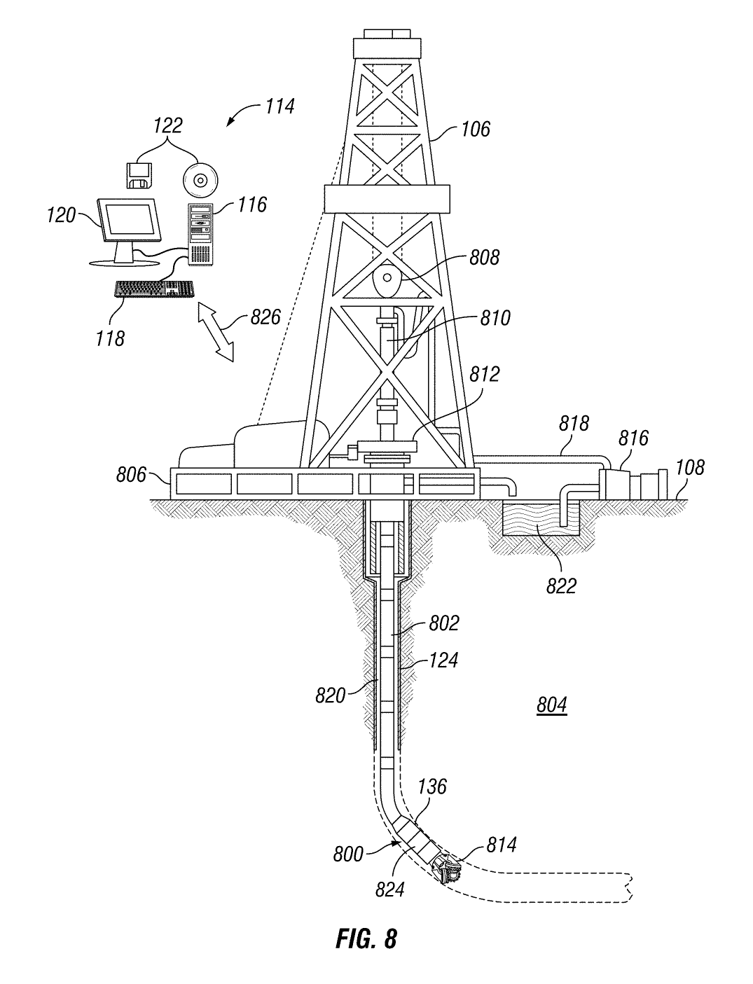

FIG. 8 illustrates an example in which a schematic diagram of a drilling system is shown. As illustrated, the drilling system may comprise quadrupole source 800 disposed on a drill string 802. As illustrated, borehole 124 may extend through subterranean formation 804. Quadrupole source 800 may be similar in configuration and operation to downhole tool 102, downhole tool 102 illustrated in FIG. 1, except that FIG. 8 shows quadrupole source 800 disposed on drill string 802. It should be noted that while FIG. 8 generally depicts a land-based drilling system, those skilled in the art will readily recognize that the principles described herein are equally applicable to subsea drilling operations that employ floating or sea-based platforms and rigs, without departing from the scope of the disclosure.

As illustrated, a drilling platform 806 may support a derrick 106 having a traveling block for raising and lowering drill string 802. Drill string 802 may include, but is not limited to, drill pipe and coiled tubing, as generally known to those skilled in the art. A kelly 810 may support drill string 802 as it may be lowered through a rotary table 812. A drill bit 814 may be attached to the distal end of drill string 802 and may be driven either by a downhole motor and/or via rotation of drill string 802 from the surface 108. Drill bit 814 may include, roller cone bits, PDC bits, natural diamond bits, any hole openers, reamers, coring bits, and the like. As drill bit 814 rotates, it may create and extend borehole 124 that penetrates various subterranean formations 804. A pump 816 may circulate drilling fluid through a feed pipe 818 to kelly 810, downhole through interior of drill string 802, through orifices in drill bit 814, back to surface 108 via annulus 820 surrounding drill string 802, and into a retention pit 822.

Drill bit 814 may be just one piece of a downhole assembly that may include one or more drill collars 824 and quadrupole source 800. Quadrupole source 800, which may be built into the drill collars 824) may gather measurements and fluid samples as described herein. As previously described, information from quadrupole source 800 may be transmitted to an information handling system 114, which may be located at surface 108. As illustrated, communication link 826 (which may be wired or wireless, for example) may be provided that may transmit data from quadrupole source 800 to an information handling system 114 at surface 108.

This method and system may include any of the various features of the compositions, methods, and system disclosed herein, including one or more of the following statements.

Statement 1: A method for well logging comprising: recording a pressure wave at a dipole receiver; processing the pressure wave with a Fourier transform; computing a frequency semblance from the Fourier transform; computing an adaptive weighting function; and estimating a shear wave slowness.

Statement 2: The method of statement 1, wherein the frequency semblance comprises a first category that produces a slowness values for one or more modes as a function of frequency and a second category that produces a coherence map.

Statement 3: The method of statement 2 or statement 1, identifying a portion on the coherence map where one of the modes is present.

Statement 4: The method of any preceding statement, wherein the frequency semblance produces a coherence map or an auxiliary fitness function with characteristics equivalent to the coherence map.

Statement 5: The method of any preceding statement, wherein the coherence map or equivalent auxiliary fitness function is compressed in frequency to produce a variable density log, wherein the variable density log is a document tracking slowness versus depth.

Statement 6: The method of any preceding statement, comprising producing a dispersion curve from a coherence map and the adaptive weighting function from one or more metrics.

Statement 7: The method of any preceding statement, wherein the adaptive weighting function and a combination of the coherence map and the dispersion curve are used for estimating the shear wave slowness.

Statement 8: The method of any preceding statement, comprising preparing an acoustic well log from the adaptive weighting function and a combination of a coherence map and a dispersion curve.

Statement 9: The method of any preceding statement, wherein the shear wave slowness is plotted in a variable density log.

Statement 10: The method of any preceding statement, further comprising preparing an acoustic well log comprising the shear wave slowness.

Statement 11: A method for well logging comprising: disposing a downhole tool into a borehole, wherein the downhole tool comprises a dipole transmitter and a dipole receiver; activating the dipole transmitter, wherein a pressure wave is transmitted; sensing the pressure wave with the dipole receiver; recording the pressure wave; processing the pressure wave with a Fourier transform; computing a frequency semblance from the Fourier transform; and estimating a shear wave slowness, wherein the estimating comprises: producing one or more adaptive weights and a combination of a coherence map and a dispersion curve; and preparing an acoustic well log from the adaptive weights and the combination of the coherence map and the dispersion curve.

Statement 12: The method of statement 11, wherein the frequency semblance comprises a first category that produces a slowness values for one or more modes as a function of frequency and a second category that produces the coherence map over slowness and frequency.

Statement 13: The method of statement 12 or statement 11, wherein a value higher than a predetermined value of coherence on the coherence map indicates one of the modes is present.

Statement 14: The method of any one of statements 11 to 13, wherein the frequency semblance produces the coherence map or an auxiliary fitness function with characteristics equivalent to the coherence map.

Statement 15: The method of any one of statements 11 to 14, wherein the coherence map or an equivalent auxiliary fitness function is compressed in frequency to produce a variable density log.

Statement 16: The method of any one of statements 11 to 15, wherein the variable density log tracks slowness versus depth.

Statement 17: The method of any one of statements 11 to 16, wherein the variable density log identifies a reservoir.

Statement 18: The method of any one of statements 11 to 17, wherein the one or more adaptive weights and a combination of the coherence map and the dispersion curve are used to estimate the shear wave slowness.

Statement 19: The method of any one of statements 11 to 18, wherein the shear wave slowness is plotted in a variable density log.

Statement 20: The method of any one of statements 11 to 19, wherein the acoustic well log comprises the shear wave slowness.

The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods can also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only, and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method for well logging comprising:
recording a pressure wave at a dipole receiver;
processing the pressure wave with a Fourier transform;
computing a frequency semblance from the Fourier transform;
computing an adaptive weighting function; and
estimating a shear wave slowness.

2. The method of claim 1, wherein the frequency semblance comprises a first category that produces a slowness values for one or more modes as a function of frequency and a second category that produces a coherence map.

3. The method of claim 2, identifying a portion on the coherence map where one of the modes is present.

4. The method of claim 1, wherein the frequency semblance produces a coherence map or an auxiliary fitness function with characteristics equivalent to the coherence map.

5. The method of claim 4, wherein the coherence map or equivalent auxiliary fitness function is compressed in frequency to produce a variable density log, wherein the variable density log is a document tracking slowness versus depth.

6. The method of claim 1, comprising producing a dispersion curve from a coherence map and the adaptive weighting function from one or more metrics.

7. The method of claim 6, wherein the adaptive weighting function and a combination of the coherence map and the dispersion curve are used for estimating the shear wave slowness.

8. The method of claim 1, comprising preparing an acoustic well log from the adaptive weighting function and a combination of a coherence map and a dispersion curve.

9. The method of claim 8, wherein the shear wave slowness is plotted in a variable density log.

10. The method of claim 1, further comprising preparing an acoustic well log comprising the shear wave slowness.

11. A method for well logging comprising:
disposing a downhole tool into a borehole, wherein the downhole tool comprises a dipole transmitter and a dipole receiver;
activating the dipole transmitter, wherein a pressure wave is transmitted;
sensing the pressure wave with the dipole receiver,
recording the pressure wave;
processing the pressure wave with a Fourier transform;
computing a frequency semblance from the Fourier transform; and
estimating a shear wave slowness, wherein the estimating comprises:
producing one or more adaptive weights and a combination of a coherence map and a dispersion curve; and
preparing an acoustic well log from the adaptive weights and the combination of the coherence map and the dispersion curve.

12. The method of claim 11, wherein the frequency semblance comprises a first category that produces a slowness values for one or more modes as a function of frequency and a second category that produces the coherence map over slowness and frequency.

13. The method of claim 12, wherein a value higher than a predetermined value of coherence on the coherence map indicates one of the modes is present.

14. The method of claim 11, wherein the frequency semblance produces the coherence map or an auxiliary fitness function with characteristics equivalent to the coherence map.

15. The method of claim 14, wherein the coherence map or an equivalent auxiliary fitness function is compressed in frequency to produce a variable density log.

16. The method of claim 15, wherein the variable density log tracks slowness versus depth.

17. The method of claim 15, wherein the variable density log identifies a reservoir.

18. The method of claim 11, wherein the one or more adaptive weights and a combination of the coherence map and the dispersion curve are used to estimate the shear wave slowness.

19. The method of claim 18, wherein the shear wave slowness is plotted in a variable density log.

20. The method of claim 11, wherein the acoustic well log comprises the shear wave slowness.
